(19) United States
(12) Patent Application Publication
(10) Pub. No.: US 2026/0344664 A1
(43) Pub. Date: Nov. 5, 2026

(54) METHOD FOR IMPROVING YELLOW INNER-LEAF COLORATION OF CHINESE CABBAGE BY EXOGENOUS APPLICATION OF ASPARAGINE AND USES THEREOF

(71) Applicant: BAAFS, Beijing (CN)

(72) Inventors: Tongbing SU, Beijing (CN); Bin ZHANG, Beijing (CN); Shuancang YU, Beijing (CN); Xiaoyun XIN, Beijing (CN); Weihong WANG, Beijing (CN); Peirong LI, Beijing (CN); Yangjun YU, Beijing (CN); Xiuyun ZHAO, Beijing (CN); Deshuang ZHANG, Beijing (CN); Fenglan ZHANG, Beijing (CN)

(73) Assignee: BAAFS, Beijing (CN)

(21) Appl. No.: 19/463,462

(22) Filed: Jan. 29, 2026

(30) Foreign Application Priority Data
Apr. 29, 2025 (CN) 202510553521.8

(51) Int. Cl. A01N 37/46; A01G 22/15; A01P 21/00

(52) U.S. Cl. CPC A01N 37/46; A01G 22/15; A01P 21/00

(57) ABSTRACT

Asparagine is used for improving the yellow inner-leaf coloration of Chinese cabbage. The technical problem solved is to improve the carotenoid content and the yellow inner-leaf coloration of Brassica plants. Specifically, it discloses the use of asparagine or a salt thereof, or a solvate thereof, in the improvement of the carotenoid content and the yellow inner-leaf coloration of Brassica plants. Applying the above substances to Brassica plants can improve the carotenoid content and increase the yellow inner-leaf coloration, which is useful in agricultural production.

### CROSS-REFERENCE TO RELATED APPLICATION

This application claims foreign priority benefits under 35 U.S.C. § 119(a)-(d) to Chinese Patent Application No. 202510553521.8, filed on Apr. 29, 2025, the disclosure of which is hereby incorporated herein by reference in its entirety.

### TECHNICAL FIELD

The present disclosure relates to the technical field of molecular biology, in particular to a method for improving the yellow inner-leaf coloration of Chinese cabbage by exogenously applying asparagine and uses thereof.

### BACKGROUND

Chinese cabbage (Brassica rapa L. ssp. pekinensis) originates in China. It is annually planted in an area of about 27 million mu (traditional Chinese unit, 1 mu≈666.67 m²), one of the major vegetable crops with the largest cultivation area in China, and plays an important role in the year-round supply and emergency security of vegetables. The market demand for yellow-hearted Chinese cabbage is increasing because of its bright yellow inner leaves, good marketability, high lutein content, and abundant nutrition. Although China has had yellow-hearted Chinese cabbage since ancient times, the market did not have a particular demand for the yellow inner-leaf coloration of Chinese cabbage at that time, so the trait yellow heart did not receive sufficient attention. In recent years, Japan and South Korea, driven by the high demand for the yellow heart trait in pickle processing, have improved the yellow inner leaves, quality, and bolting resistance of Chinese cabbage, capturing the majority of the market share. Therefore, there is an urgent need to cultivate fresh, yellow-hearted, high-quality Chinese cabbage. How to improve the yellow inner-leaf coloration of Chinese cabbage is a technical problem faced by those skilled in the art.

### SUMMARY

The technical problem solved by the present disclosure is to improve the yellow inner-leaf coloration and the carotenoid content of Brassica plants. Applying the above substances to Brassica plants can improve the carotenoid content and increase the yellow inner-leaf coloration.

In a first aspect, the present disclosure provides a method for improving the yellow inner-leaf coloration and the carotenoid content of a Brassica plant, comprising the step of applying asparagine or a salt thereof, or a product containing asparagine or a salt thereof, to the Brassica plant in the cultivation of the Brassica plant.

In another aspect, the present disclosure provides a method for cultivating a Brassica plant, comprising the step of applying asparagine or a salt thereof, or a product containing asparagine or a salt thereof, to the Brassica plant.

In some embodiments, the product comprises a composition, a heading agent, and/or a plant growth promoter.

In some embodiments, an application period is from the rosette stage to the heading stage.

In some embodiments, the asparagine is applied in an amount of 100-300 mg/Brassica plant.

In some embodiments, an amount applied is 200 mg/Brassica plant.

In some embodiments, asparagine is applied at a concentration of 20-60 mg/mL.

In some embodiments, a concentration applied is 40 mg/mL.

In some embodiments, asparagine is applied at a frequency of twice/week.

In another aspect, the present disclosure provides a composition, comprising asparagine or a salt thereof, a solvate thereof, or any combination thereof.

In some embodiments, the composition is a heading agent or a plant growth promoter.

In some embodiments, a time for said applying is 17:00-18:00.

In some embodiments, a time for said applying is 17:01, 17:02, 17:03, 17:04, 17:05, 17:06, 17:07, 17:08, 17:09, 17:10, 17:11, 17:12, 17:13, 17:14, 17:15, 17:16, 17:17, 17:18, 17:19, 17:20, 17:21, 17:22, 17:23, 17:24, 17:25, 17:26, 17:27, 17:28, 17:29, 17:30, 17:31, 17:32, 17:33, 17:34, 17:35, 17:36, 17:37, 17:38, 17:39, 17:40, 17:41, 17:42, 17:43, 17:44, 17:45, 17:46, 17:47, 17:48, 17:49, 17:50, 17:51, 17:52, 17:53, 17:54, 17:55, 17:56, 17:57, 17:58, 17:59, or 18:00.

In another aspect, the present disclosure provides the use of asparagine or a salt thereof, or a solvate thereof, in the improvement of the carotenoid content and/or the yellow inner-leaf coloration of a Brassica plant.

In another aspect, the present disclosure provides a composition, comprising asparagine or a salt thereof, a solvate thereof, or any combination thereof.

In some embodiments, the composition is used to improve the agricultural traits of a plant.

In some embodiments, the improvement of agricultural traits includes increasing the yellow inner-leaf coloration.

In some embodiments, the composition is used in a plant from the rosette stage to the heading stage.

In some embodiments, the composition is formulated as a solid preparation or a liquid preparation.

In some embodiments, the composition further comprises an excipient and/or an additive.

In some embodiments, the excipient includes an agriculturally or horticulturally acceptable diluent, filler, solvent, carrier, emulsifier, dispersant, thickener, binder, or any combination thereof.

In some embodiments, the additive includes an agriculturally or horticulturally acceptable preservative, adjuvant, synergist, microbial additive, antifreezing agent, or any combination thereof.

In some embodiments, the composition is a liquid preparation.

In some embodiments, the liquid preparation comprises an emulsifiable concentrate, a soluble concentrate, an oil miscible liquid, a dispersible concentrate, an electrochargeable liquid, a suspension concentrate, a capsule suspension, an oil miscible flowable concentrate, a suspo-emulsion, an emulsion in water, a microemulsion, a nanoemulsion, or any combination thereof.

In some embodiments, in the above liquid preparation, the asparagine is present in an agriculturally or fertilizer acceptable carrier.

In some embodiments, the asparagine content in the liquid preparation is 20-60 mg/mL.

In some embodiments, the asparagine content in the liquid preparation is 40 mg/mL.

In some embodiments, the liquid preparation is used in root soaking, foliar spraying, mist spraying, composting, seed soaking, coating, field flooding, drop irrigation of a plant or plant organ, smearing a plant or plant organ, dripping a plant or plant organ, or any combination thereof.

In some embodiments, the composition is a solid preparation.

In some embodiments, in the solid preparation, asparagine is present in an agriculturally or fertilizer acceptable carrier.

In some embodiments, the solid preparation is used for composting, smearing a plant or plant organ, or any combination thereof.

In some embodiments, the solid preparation is used to formulate the above liquid preparation.

In some embodiments, the solid preparation or liquid preparation is selected from a foliar treatment dosage form, a soil treatment dosage form, a seed treatment dosage form, a stem treatment dosage form, a root treatment dosage form, or any combination thereof.

In some embodiments, the plant is a plant at a stage from the rosette stage to the heading stage.

In another aspect, the present disclosure provides a heading agent comprising any of the compositions as described above.

In another aspect, the present disclosure provides a plant growth promoter comprising any of the compositions as described above.

In another aspect, the present disclosure provides a method for cultivating a Brassica plant, the method comprising the step of applying asparagine or a salt thereof, any of the compositions as described above, the above heading agent, and the above plant growth promoter to a Brassica plant tissue and/or organ.

In some embodiments, said applying comprises one or more of root soaking, foliar spraying, mist spraying, composting, seed soaking, coating, field flooding, drop irrigation of a plant or plant organ, smearing a plant or plant organ, and dripping a plant or plant organ.

In some embodiments, the application period is from the rosette stage to the heading stage.

In some embodiments, in the foliar spraying, asparagine is applied at a concentration of 20-60 mg/mL.

In some embodiments, in the foliar spraying, asparagine is applied at a concentration of 40 mg/mL.

In some embodiments, in the foliar spraying, the foliar spraying is applied in an amount of 5 mL/plant.

In some embodiments, in the foliar spraying, the frequency of foliar spraying is twice/week.

In some embodiments, the method is used to obtain a Brassica plant having a high carotenoid content.

In some embodiments, the Brassica plant having a high carotenoid content has a carotenoid content above Brassica plants obtained without the application of the composition, the heading agent, or the plant growth promoter.

In some embodiments, the method is used to obtain a Brassica plant having a high yellow inner-leaf coloration.

In some embodiments, the Brassica plant having a high yellow inner-leaf coloration has a yellow inner-leaf coloration above Brassica plants obtained without application of the composition, the heading agent, or the plant growth promoter.

In some embodiments, the yellow inner-leaf coloration refers to the area percentage or volume percentage of the yellow region.

In some embodiments, the Brassica plant has yellow inner-leaf coloration at the heading stage.

In some embodiments, the Brassica plant has a high carotenoid content at the heading stage.

In another aspect, the present disclosure provides a method for improving the yellow inner-leaf coloration of a Brassica plant, the method comprising the step of applying asparagine or a salt thereof, any of the compositions as described above, the above heading agent, and the above plant growth promoter to the Brassica plant in the cultivation of the Brassica plant.

In some embodiments, the Brassica plant includes a Brassica plant tissue and/or a Brassica plant organ.

In some embodiments, the Brassica plant tissue and/or organ includes a root, a stem, a leaf, a flower, a fruit, a seed, or any combination thereof.

In some embodiments, the applying comprises one or more of root soaking, foliar spraying, mist spraying, composting, seed soaking, coating, field flooding, drop irrigation of a plant or plant organ, smearing a plant or plant organ, and dripping a plant or plant organ.

In some embodiments, the application period is from the rosette stage to the heading stage.

In some embodiments, in the foliar spraying, the asparagine is applied at a concentration of 20-60 mg/mL.

In some embodiments, in the foliar spraying, the asparagine is applied at a concentration of 40 mg/mL.

In some embodiments, in the foliar spraying, the foliar spraying is applied in an amount of 5 mL/plant.

In some embodiments, in the foliar spraying, the frequency of foliar spraying is twice/week.

In some embodiments, the method is used to obtain a Brassica plant having a high carotenoid content.

In some embodiments, the Brassica plant having a high carotenoid content has a carotenoid content above Brassica plants obtained without the application of the composition, the heading agent, or the plant growth promoter.

In some embodiments, the method is used to obtain a Brassica plant having a high yellow inner-leaf coloration.

In some embodiments, the Brassica plant having a high yellow inner-leaf coloration has a yellow inner-leaf coloration above Brassica plants obtained without application of the composition, the heading agent, the plant growth promoter.

In some embodiments, the yellow inner-leaf coloration refers to the area percentage or volume percentage of the yellow region.

In some embodiments, the Brassica plant has a yellow inner-leaf coloration at the heading stage.

In some embodiments, the Brassica plant has a high carotenoid content at the heading stage.

In another aspect, the present disclosure provides the use of any of the compositions as described above, the above heading agent, and the above plant growth promoter in the improvement of the carotenoid content and the yellow inner-leaf coloration of a Brassica plant.

In some embodiments, the yellow inner-leaf coloration refers to the area percentage or volume percentage of the yellow region.

In some embodiments, the plant is a plant leaf.

In some embodiments, the asparagine is L-asparagine.

In some embodiments, for any of the compositions as described above, the above heading agent, the above plant growth promoter, the above method, or the above use, the Brassica plant is selected from Chinese cabbage, bok choy, choy sum, or any combination thereof.

In some embodiments, the Chinese cabbage is selected from Tianjin Qingmaye, Yutian Baojian cabbage, Jincai No. 3, Jiaozhou Chinese cabbage, Fushan Baotou, Beijing New No. 3, Taiyuan Erbaotou, Luoyang Dabaotou, Beijing Xiaoza No. 56, Lubai No. 6, Chundajiang, Jinguan, Ziyi, or any combination thereof.

In some embodiments, the bok choy is selected from Shanghai Qing, Suzhou Qing, Aijiao Huang, Jiangan Bai, Hangzhou Youdong'er, Ma'ertou, or any combination thereof.

In some embodiments, the choy sum is selected from Sijiu Caixin, Youqing Tiancaixin, Liuye Zaocaixin, Qingliuye Caixin, Huangye Zhongxin, Chixin No. 2, Sanyue Qing, Hongfu No. 1, Yueyou No. 1, or any combination thereof. In another aspect, the present disclosure provides the use of asparagine or a salt thereof, or a solvate thereof, in the improvement of the carotenoid content and/or the yellow inner-leaf coloration of a Brassica plant.

In some embodiments, the yellow inner-leaf coloration refers to the area percentage or volume percentage of the yellow region.

In some embodiments, the plant is a plant leaf.

In some embodiments, the asparagine is L-asparagine.

In some embodiments, the Brassica plant is selected from Chinese cabbage, bok choy, choy sum, or any combination thereof.

In some embodiments, the Chinese cabbage is a Chinese cabbage variety Beijing New No. 3.

In some embodiments, the use is for the preparation of a related product. The product is a composition,

In some embodiments, the composition further comprises one or more chemical agents.

In some embodiments, the composition further comprises an agriculturally or horticulturally acceptable diluent, filler, solvent, spontaneous promoter, carrier, emulsifier, preservative, dispersant, antifreezing agent, thickener, adjuvant, synergist, microbial additive, binder, plant growth regulator, or any combination thereof.

In some embodiments, the dispersant and/or emulsifier includes all nonionic, anionic or cationic dispersants conventionally used in preparations of agriculturally active chemical components.

In some embodiments, examples of the preservative include, but are not limited to, dichlorophen and benzylhemiformal.

In some embodiments, examples of the binder include, but are not limited to, starch, polyvinyl alcohol, and gelatin.

In some embodiments, examples of the dispersant include, but are not limited to, sodium dodecylbenzenesulfonate and sodium butylnaphthalenesulfonate.

In some embodiments, examples of the stabilizer include, but are not limited to, fumed silica, talc, and dicyandiamide.

In some embodiments, examples of the synergist include, but are not limited to, compound sodium nitrophenolate and vitamin C.

In some embodiments, examples of the filler include, but are not limited to, a volcanic rock powder and ammonium bicarbonate.

In some embodiments, examples of the plant growth regulator include, but are not limited to, 28-homobrassinolide, brassinolide, and natural pigments (such as β-carotene).

In some embodiments, examples of the agriculturally or horticulturally acceptable diluent include an aqueous solution of monosaccharide, polysaccharide, molasses, gum, lignin sulfonate, glycerol, sorbitol, or propylene glycol, water, a vegetable oil, and a mineral oil.

In some embodiments, the carrier can include a solid of alginate beads, durum flour particles, silica, clay, clay minerals, gelatin, cellulose, a cellulose derivative, calcium chlorite and talc, diatomite, activated carbon, animal bone carbon, peat, vermiculite, lignite, wood chips, and/or corn cob.

In some embodiments, the chemical agent is selected from a herbicide, an insecticide, an antimicrobial agent, an antiviral agent, a plant growth regulator, an antibiotic, a fertilizer, or any combination thereof.

In some embodiments, the antimicrobial agent is selected from propamocarb hydrochloride, carbendazim, fluazinam, chlorothalonil, quintozene, thiram, fosetyl-aluminum, metalaxyl-M, metalaxyl-M·fludioxonil, or any combination thereof.

Preferably, the insecticide is selected from thiamethoxam, dinotefuran, gamma-cyhalothrin, profenofos·phoxim, or any combination thereof.

In some embodiments, the fertilizer is selected from urea, ammonium sulfate, Huanzhitian, Antang Keli, potassium dihydrogen phosphate, or any combination thereof.

In some embodiments, the foliar spraying of asparagine produces the following effects: Asparagine enters the plant to play its role, and can be transported to plant leaves or other plant organs through the xylem. Therefore, those skilled in the art can conclude that root soaking, foliar spraying, mist spraying, composting, seed soaking, coating, field flooding, drop irrigation of the plant or plant organ, smearing the plant or plant organ, and dripping the plant or plant organ all can achieve the relevant technical effects.

In some embodiments, the composition is a liquid fertilizer.

In some embodiments, in the composition, asparagine is present in a fertilizer acceptable carrier.

In some embodiments, the liquid fertilizer is either a clear liquid fertilizer or a suspension fertilizer.

In some embodiments, the asparagine content in the liquid fertilizer is 20-60 mg/mL. In some embodiments, the asparagine content is 21-59 mg/mL, 22-58 mg/mL, 23-57 mg/mL, 24-66 mg/mL, 25-55 mg/mL, 26-54 mg/mL, 27-53 mg/mL, 28-52 mg/mL, 29-51 mg/mL, 30-50 mg/mL, 31-49 mg/mL, 32-48 mg/mL, 33-47 mg/mL, 34-46 mg/mL, 35-45 mg/mL, 36-44 mg/mL, 37-43 mg/mL, 38-42 mg/mL, 39-41 mg/mL, or 40 mg/mL.

In some embodiments, the asparagine content is 40 mg/mL.

In some embodiments, the composition is used in one or more of root soaking, foliar spraying, mist spraying, composting, seed soaking, coating, field flooding, drop irrigation of a plant or plant organ, smearing a plant and plant organ, and dripping a plant or plant organ.

In some embodiments, the above operation is performed from the rosette stage to the heading stage.

In some embodiments, the above operation is performed at 5 mL/plant.

In some embodiments, L-asparagine is sprayed on the foliar in the foliar spraying.

In some embodiments, the composition is a solid fertilizer or a powder fertilizer.

In some embodiments, in the composition, asparagine is present in a fertilizer-acceptable carrier.

In some embodiments, the composition is used for composting, smearing a plant or plant organ, or any combination thereof.

In some embodiments, the powder fertilizer is used to formulate the above liquid fertilizer.

In some embodiments, the composition is a powder fertilizer. The powder fertilizer is used to formulate the above liquid fertilizer or the above solid fertilizer.

In another aspect, the present disclosure provides a heading agent comprising the above composition, the above liquid fertilizer, the above solid fertilizer, or the powder fertilizer.

In another aspect, the present disclosure provides a plant growth promoter comprising the above composition, the above liquid fertilizer, the above solid fertilizer, or the powder fertilizer.

In another aspect, the present disclosure provides a method for cultivating Chinese cabbage, comprising either of the following:
(1) The method comprises the step of applying the above composition, the above liquid fertilizer, the above solid fertilizer, the above heading agent and/or the above plant growth promoter to a Chinese cabbage tissue and/or organ to obtain Chinese cabbage having a high carotenoid content, wherein the Chinese cabbage having a high carotenoid content is higher than that of Chinese cabbage obtained without the application of the above or aforementioned products;
(2) The method comprises the step of applying the above composition, the above liquid fertilizer, the above solid fertilizer, the above heading agent and/or the above plant growth promoter to a Chinese cabbage tissue and/or organ to obtain Chinese cabbage having a high yellow inner-leaf coloration, wherein the yellow inner-leaf coloration of the Chinese cabbage having a high yellow inner-leaf coloration is higher than that of Chinese cabbage obtained without the application of the above or aforementioned products.

In some embodiments, the yellow inner-leaf coloration refers to the area percentage or volume percentage of the yellow region.

In some embodiments, the applying comprises one or more of root soaking, foliar spraying, mist spraying, composting, seed soaking, coating, field flooding, drop irrigation of a plant or plant organ, smearing a plant or plant organ, and dripping a plant or plant organ.

In some embodiments, the foliar spraying is applied at 5 mL/plant twice/week.

In some embodiments, the foliar spraying is applied at 5 mL/plant once/3.5 days.

In some embodiments, the application period is from the rosette stage to the heading stage.

In some embodiments, the Brassica plant has a high yellow inner-leaf coloration at the heading stage.

In some embodiments, the Brassica plant has a high carotenoid content at the heading stage.

### Beneficial Effects

L-Asparagine (L-Asn) is one of the most common amino acids in living organisms and has been widely applied in various fields. In the pharmaceutical field, it is useful in the treatment of heart diseases, liver diseases, and hypertension, and for relieving fatigue; in the industrial field, it can be used as a food additive to improve the nutritive value and taste of food; in the agricultural field, it can be used as a plant growth regulator to promote plant growth and development and improve crop quality.

The present disclosure discloses a method for improving the yellow inner-leaf coloration of Chinese cabbage by exogenously applying asparagine and uses thereof. The technical problem solved is to improve the carotenoid content and the yellow inner-leaf coloration of Brassica plants. Specifically, it discloses the use of asparagine or a salt thereof, or a solvate thereof, in the improvement of the carotenoid content and the yellow inner-leaf coloration of Brassica plants. Applying the above substances to Brassica plants can improve the carotenoid content and increase the yellow inner-leaf coloration, which is useful in agricultural production.

### BRIEF DESCRIPTION OF THE DRAWINGS

FIG. 1 shows the yellow-heart phenotype of Chinese cabbage in various treatment groups provided in Example 1 of the present disclosure.

FIG. 2 shows the total carotenoid content in the heart leaves of Chinese cabbage in various treatment groups provided in Example 1 of the present disclosure.

### DETAILED DESCRIPTION

The present disclosure will be further described in detail below with reference to specific embodiments. The embodiments given are for illustrative purposes only and are not intended to limit the scope of the disclosure. The embodiments provided below can serve as a guide for those of ordinary skill in the art to make further modifications, and do not constitute a limitation on the present disclosure in any way.

Unless otherwise specified, the experimental procedures in the following examples are all conventional procedures, following the techniques or conditions described in the literature of the art or the product instructions. Unless otherwise specified, all materials and reagents used in the following examples are commercially available.

The following examples use the statistical software SPSS 11.5 to process data. The experimental results are expressed as mean±standard deviation, and verified using One-way ANOVA. P<0.05 (*) indicates a significant difference, and P<0.01 (**) indicates a highly significant difference.

In the present disclosure, unless otherwise specified, scientific and technical terms used herein have the meanings commonly understood by those skilled in the art. Furthermore, the terms and laboratory steps related to protein and nucleic acid chemistry, molecular biology, cell and tissue culture, microbiology, and immunology used herein are all widely used terms and routine steps in the corresponding fields. Moreover, to better understand the present disclosure, definitions and explanations of relevant terms are provided below.

As used herein, the term “Trp” refers to tryptophan, also known as β-indolylalanine, an organic compound in the chemical formula C₁₁H₁₂N₂O₂. In the examples, it specifically refers to L-tryptophan (L-Trp), its structural formula is as follows:

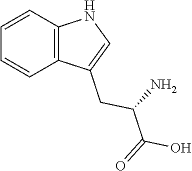 [SMILES: N[C@@H](Cc1c[nH]c2ccccc12)C(=O)O]

As used herein, the term “Asn” refers to asparagine (Aspartic acid), also known as aspartic acid, an organic compound in the chemical formula C₄H₇NO₄. In the examples, it specifically refers to L-asparagine (L-Asn), its structural formula is as follows:

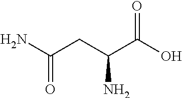

As used herein, the terms “comprising,” “including,” “having,” “containing,” and the like are open-ended languages, indicating including but not limited to.

As used herein, the terms “first” and “second” are used merely for the descriptive purposes, and shall not be construed as indicating or suggesting relative importance or implicitly specifying the number of technical features indicated. Thus, the features defined with “first” and “second” may explicitly or implicitly include one or more of the features. Further, in the description of the present disclosure, “more” indicates two or above unless otherwise specified.

As used herein, the terms “optionally,” “optional,” or “option” generally mean that an event or circumstance described below may, but not necessarily, occur, and that the description includes instances where the event or circumstance occurs and instances where the event or circumstance does not occur.

As used herein, the term “rosette stage” refers to the transitional phase from the end of the seedling stage to the beginning of the heading stage. Specifically, it refers to the phase from when the Chinese cabbage grows eight true leaves to the beginning of the heading stage.

As used herein, the term “heading stage” refers to the phase when the outer leaves (rosette leaves) of the Chinese cabbage stop growing and the heart leaves begin to curl inward to form a head.

As used herein, the term “yellow inner-leaf coloration” refers to the degree to which the inner leaves of the head have turned yellow, and is commonly used to assess the quality of leafy vegetables such as Chinese cabbage and cabbage.

### Example 1. Exogenous Application of L-Asparagine (L-Asn) Protocol

The test material was the Chinese cabbage variety Beijing New No. 3, sourced from the Vegetable Research Institute of Beijing Academy of Agricultural and Forestry Sciences. It was sown and planted at the Sijiqing Farm of the Vegetable Research Institute of Beijing Academy of Agricultural and Forestry Sciences, under conventional cultivation and management.

This experiment involved three groups: a control group, an L-Asn group (experimental group), and an L-Trp group (the control group was sprayed with H₂O, the L-Trp group was sprayed with L-Trp, and the L-Asn group (experimental group) was sprayed with L-Asn). Five replicates had been set for each group. In the preliminary stage, we conducted a screening experiment for the optimal spraying method of L-Asn. The selected ranges of spraying time were 7:00-10:00, 11:00-14:00, and 16:00-19:00; the selected range of spraying concentration was 10 mg/mL-80 mg/mL; and the selected spraying frequency was 1-7 times per week. Finally, we determined the optimal spraying method for L-Asn: from the rosette stage, at 17:00-18:00, spraying a 40 mg/mL L-Asn solution evenly onto the leaves of Chinese cabbage in the form of water fog, twice per week, continuously until the heading stage.

### Example 2. Investigation of Agronomic Traits in Various Treatment Groups

The Chinese cabbage variety Beijing New No. 3 (from the Vegetable Research Institute of Beijing Academy of Agricultural and Forestry Sciences) was sown at the Sijiqing Farm of the Vegetable Research Institute of Beijing Academy of Agricultural and Forestry Sciences on Aug. 10, 2024, under conventional cultivation and management. In this experiment, the Chinese cabbage variety Beijing New No. 3 was randomly divided into three groups: a control group, an L-Asn group (experimental group), and an L-Trp group (the control group was sprayed with H₂O, the L-Trp group was sprayed with L-Trp, and the L-Asn group (experimental group) was sprayed with L-Asn). Each group involved five plants, and three replicates were set for each group. When the Chinese cabbage variety Beijing New No. 3 grew to the rosette stage, the experimental group was sprayed with a 40 mg/mL L-Asn solution (water as solvent) in an amount of 5 mL per plant evenly onto the leaves of Chinese cabbage in the form of water fog at 17:00-18:00. The control group was sprayed with the same amount of solvent (water) in the same procedure. The L-Trp group was sprayed with the same amount of a 40 mg/mL L-Trp solution (water as solvent) in the same procedure. All these groups were continuously sprayed twice a week until the heading stage. Three uniformly growing plants were selected from each treatment group to measure the plant height, plant spacing, gross weight, net weight, head height, head width, and central column length. It is found that compared to H₂O and L-Trp spraying, the plant height of L-Asn-sprayed plants was significantly reduced, while other agronomic traits showed no significant differences (specifically, as shown in Table 1).

Plant height: from the soil surface to the tip of the highest leaf.

Plant spacing: the distance between the two furthest leaves.

Gross weight: the weight of the entire plant (excluding the portion below the soil surface).

Net weight: the weight of the entire head (excluding the portion below the soil surface and the outer leaves).

Head height: the vertical height from the base of the head to the tip of the head.

Head width: the horizontal distance from one edge of the widest part of the head to the other edge.

Central column length: the vertical length from the base to the tip of the central column.

TABLE 1
Agronomic traits of various treatment groups

| | Plant | Plant | Gross | Net | Head | Head | Central |
|---|---|---|---|---|---|---|---|
| | height | spacing | weight | weight | height | width | column |
| Samples | (cm) | (cm) | (cm) | (cm) | (cm) | (cm) | length (cm) |
| Control group- | 48 | 80 | 5.3 | 3.7 | 36 | 19 | 4.3 |
| 1 | | | | | | | |
| Control group- | 50 | 85 | 5.1 | 3.3 | 35 | 17 | 4.4 |
| 2 | | | | | | | |
| Control group- | 48 | 82 | 5.6 | 3.2 | 36 | 18 | 4.5 |
| 3 | | | | | | | |
| Experimental | 42 | 88 | 4.8 | 3.2 | 37 | 18 | 4.7 |
| group-1 | | | | | | | |
| Experimental | 44 | 91 | 4.5 | 3.6 | 36 | 20 | 5.1 |
| group-2 | | | | | | | |
| Experimental | 41 | 89 | 4.7 | 3.0 | 35 | 18 | 4.1 |
| group-3 | | | | | | | |
| L-Trp group-1 | 49 | 91 | 5.5 | 3.5 | 41 | 18 | 4.2 |
| L-Trp group-2 | 48 | 90 | 5.6 | 3.7 | 38 | 19 | 4.1 |
| L-Trp group-3 | 49 | 90 | 5.5 | 3.3 | 39 | 18 | 4.0 |

### Example 3. Investigation of Yellow Heart Trait and Determination of Carotenoid Content in Various Treatment Groups

The Chinese cabbage variety Beijing New No. 3 up to the heading stage from Example 2 was subjected to the investigation of the yellow heart trait and the determination of the carotenoid content. Specifically:

Three plants under uniform growth were selected from each treatment group (control group, L-Asn group, and L-Trp group), named H₂O-1, H₂O-2, H₂O-3, L-Asn-1, L-Asn-2, L-Asn-3, L-Trp-1, L-Trp-2, and L-Trp-3, respectively, for the investigation of the yellow heart trait and the determination of the carotenoid content.

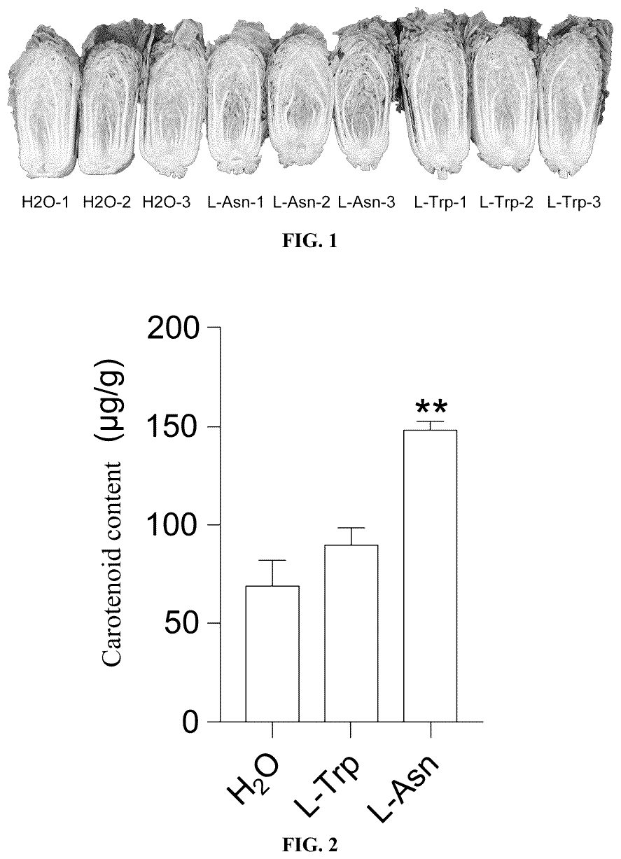

The results showed that, compared with H₂O and L-Trp spraying, L-Asn spraying significantly increased the yellow inner-leaf coloration of the plants (FIG. 1, where H₂O (H₂O-1, H₂O-2, and H₂O-3) represents the control group, L-Asn (L-Asn-1, L-Asn-2, and L-Asn-3) represents the L-Asn group, and L-Trp (L-Trp-1, L-Trp-2, and L-Trp-3) represents the L-Trp group).

Then, 0.2 g of heart leaves (the innermost 5 cm of the heart) from the same part of different treatment groups were weighed and cut into small pieces, placed into 10 mL of an 80% acetone solution, and impregnated at room temperature in the dark for 24 hours. The absorbance value of the extraction solution at 470 nm was then measured using a DU800 UV spectrophotometer. Three biological replicates were set up for each sample. The carotenoid content was calculated according to the Arnon's (1949) method: Carotenoid: Car=(1000×OD₄₇₀×V/W−3.27×Chl a−104×Chlb)/198; wherein OD₄₇₀ is an absorbance value on a DU800 UV spectrophotometer; V: a total volume of the extract (mL); W: fresh weight of leaves (g). The results showed that compared with H₂O spraying, the carotenoid content of the L-Trp-sprayed plants did not significantly change; compared with H₂O and L-Trp spraying, the carotenoid content of the L-Asn-sprayed plants significantly increased (FIG. 2, where H₂O represents the control group, L-Asn represents the L-Asn group, and L-Trp represents the L-Trp group).

In summary, the present disclosure provides a method for improving the yellow inner-leaf coloration of Chinese cabbage by exogenous application of L-Asn. This method is simple, safe, economical, and efficient in improving the yellow inner-leaf coloration and the carotenoid content of Chinese cabbage heads, and can be applied to the quality breeding of Chinese cabbage heads. Moreover, it is of great significance to study the molecular mechanism of yellow heart formation.

The present disclosure has been described in detail above. For those skilled in the art, the present disclosure can be carried out in a wide scope under equivalent parameters, concentrations, and conditions without departing from its spirit and scope and without the need for unnecessary experiments. Although specific examples are illustrated in the present disclosure, it should be understood that further modifications can be made to the present disclosure. In short, according to the principles of the present disclosure, the present application is intended to include any alterations, uses, or modifications to the present disclosure, including changes that depart from the scope of disclosure contained herein and are made using conventional techniques known in the art. Some basic features can be applied within the scope of the following appended claims.

What is claimed is:

1. A method for improving a yellow inner-leaf coloration and/or a carotenoid content of a Brassica plant, comprising a step of applying asparagine or a salt thereof, or a product containing asparagine or a salt thereof, to the Brassica plant during the cultivation of the Brassica plant.

2. The method of claim 1, wherein said applying is selected from root soaking, foliar spraying, mist spraying, composting, seed soaking, coating, field flooding, drop irrigation of a plant or plant organ, smearing a plant or plant organ, dripping a plant or plant organ, or any combination thereof.

3. The method of claim 1, a period for said applying ranges from the rosette stage to the heading stage.

4. The method of claim 1, wherein asparagine is applied in an amount of 100-300 mg/Brassica plant.

5. The method of claim 1, wherein asparagine is applied at a concentration of 20-60 mg/mL.

6. The method of claim 1, characterized in that the asparagine is applied at a frequency of twice/week.

7. The method of claim 1, wherein a time for application is 17:00-18:00.

8. The method of claim 1, wherein the Brassica plant is selected from Chinese cabbage, bok choy, choy sum, or any combination thereof.

9. A method for cultivating a Brassica plant, comprising a step of applying asparagine or a salt thereof, or a product containing asparagine or a salt thereof, to the Brassica plant.

10. The method of claim 2, wherein said applying is selected from root soaking, foliar spraying, mist spraying, composting, seed soaking, coating, field flooding, drop irrigation of a plant or plant organ, smearing a plant or plant organ, dripping a plant or plant organ, or any combination thereof.

11. The method of claim 2, a period for said applying ranges from the rosette stage to the heading stage.

12. The method of claim 2, wherein asparagine is applied in an amount of 100-300 mg/Brassica plant.

13. The method of claim 2, wherein asparagine is applied at a concentration of 20-60 mg/mL.

14. The method of claim 2, characterized in that the asparagine is applied at a frequency of twice/week.

15. The method of claim 2, wherein a time for application is 17:00-18:00.

16. The method of claim 2, wherein the Brassica plant is selected from Chinese cabbage, bok choy, choy sum, or any combination thereof.
